(19) United States
(12) Patent Application Publication
(10) Pub. No.: US 2002/0128746 A1
(43) Pub. Date: Sep. 12, 2002

(54) Apparatus, system and method for a remotely monitored and operated avatar

(75) Inventors: Stephen J. Boies, Mahopac, NY (US); Samuel H. Dinkin, Austin, TX (US); David Perry Greene, Ossining, NY (US); William Grey, Millwood, NY (US); Paul Andrew Moskowitz, Yorktown Heights, NY (US); Philip S. Yu, Chappaqua, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/794,269

(22) Filed: Feb. 27, 2001

(51) Int. Cl. G06F 19/00

(52) U.S. Cl. 700/245

(57) ABSTRACT

An apparatus, system and method for a remotely monitored and operated avatar is provided. The avatar is provided with one or more sensors for sensing environmental conditions of the environment in which the avatar is located. The one or more sensors send sensor data to a data processing system in the avatar which may perform processing and analysis on the sensor data to determine instructions for controlling the operation of the avatar such that the avatar interacts with an entity under observation. In addition, the avatar may transmit the sensor data to a remote assisted living server and/or remote observation center. The remote assisted living server and/or remote observation center may then perform processing and analysis of the sensor data to generate instructions which are transmitted to the avatar. In this way, the processing and analysis of the sensor data may be distributed amongst the avatar, the remote assisted living server, and the remote observation center, or any portion thereof. The avatar is preferably provided with aesthetic qualities that cause the entity under observation to establish a feeling of companionship with the avatar.

### RELATED APPLICATION

This application is related to similar subject matter as commonly assigned and co-pending U.S. patent application Ser. No. ______ (Attorney Docket No. YOR920000526US1), entitled “”, filed on ______, which is hereby incorporated by reference.

### BACKGROUND OF THE INVENTION

1. Technical Field

The present invention is directed to an apparatus system, and method for a remotely monitored and operated avatar. More particularly, the present invention is directed to an apparatus, system and method for providing assisted living and monitoring services using a remotely monitored and operated avatar.

2. Description of Related Art

Because of various infirmities, handicaps, and diminished capacities, certain individuals require assistance in taking care of themselves in their everyday lives. In order to provide such assistance, typically in-home nursing services, automatic medic alert monitoring services, local monitoring of children, and the like, are provided. In addition, video monitoring and audio monitoring devices have been developed for use by parents when monitoring their children. The present state of the art, therefore, is directed to direct human monitoring of persons or simply sensors that provide output to humans monitoring these sensors.

Such direct human monitoring may be very invasive to those being monitored. In addition, the current sensor devices that may be used to monitor persons are typically provided as non-interactive, sterile devices such as video cameras, microphones and speakers. There is no “companion” aspect to these sterile devices that would evoke a comfortable reaction from the persons being monitored.

### SUMMARY OF THE INVENTION

An apparatus, system and method for a remotely monitored and operated avatar is provided. The avatar is provided with one or more sensors for sensing environmental conditions of the environment in which the avatar is located. The one or more sensors send sensor data to a data processing system in the avatar which may perform processing and analysis on the sensor data to determine instructions for controlling the operation of the avatar such that the avatar interacts with an entity under observation.

In addition, the avatar may transmit the sensor data to a remote assisted living server and/or remote observation center. The remote assisted living server and/or remote observation center may then perform processing and analysis of the sensor data to generate instructions which are transmitted to the avatar. In this way, the processing and analysis of the sensor data may be distributed amongst the avatar, the remote assisted living server, and the remote observation center, or any portion thereof.

The avatar is preferably provided with aesthetic qualities that cause the entity under observation to establish a feeling of companionship with the avatar. In a preferred embodiment, the avatar takes the form of a household pet, such as a dog or cat. In this way, the entity under observation does not feel that its personal space is being invaded and complex operations for assisting the entity may be performed beyond mere observation. Other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention;

FIG. 2 is an exemplary block diagram illustrating an assisted living server according to the present invention;

FIG. 3 is an exemplary block diagram illustrating a client data processing system according to the present invention;

FIG. 4 is an exemplary block diagram illustrating a remotely monitored and operated avatar according to one embodiment of the present invention; and

FIG. 5 is a flowchart outlining an exemplary operation of the present invention.

### DETAILED DESCRIPTION OF THE PREFERRED EMBODIMENT

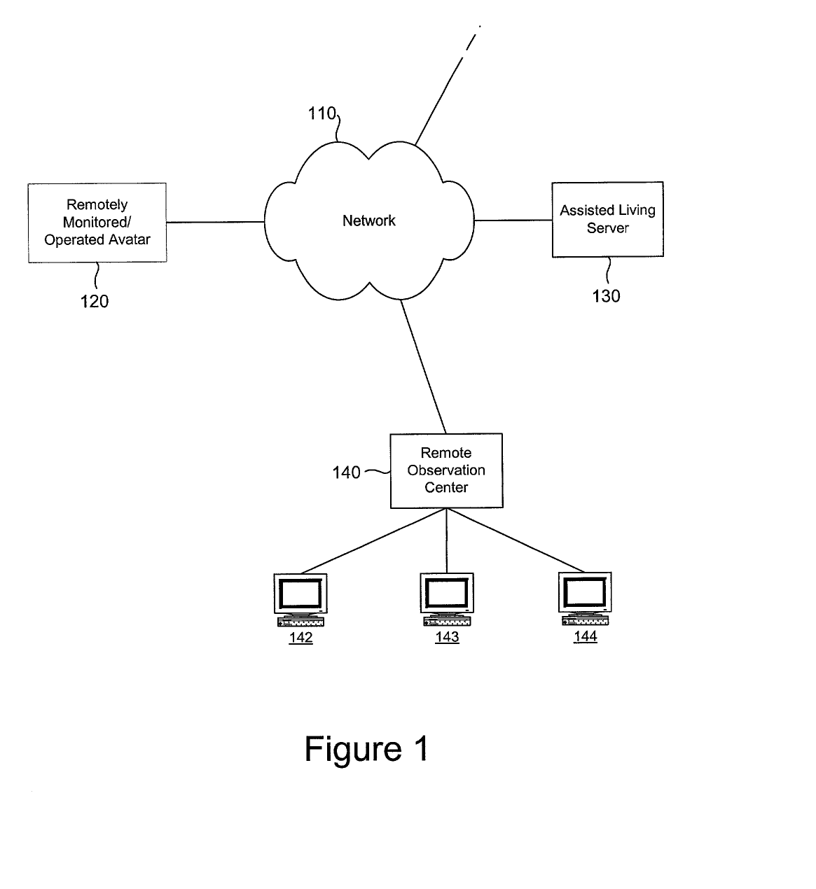

FIG. 1 is an exemplary block diagram of a distributed data processing system according to the present invention. As shown in FIG. 1, the distributed data processing system 100 includes one or more networks 110, a remotely monitored/operated avatar 120, an assisted living server 130, and a remote observation center 140. The remote observation center may, in turn, be coupled to a plurality of operator stations 142-144. The distributed data processing system 100 may include additional assisted living servers, remotely monitored/operated avatars, remote observation centers, and other devices not explicitly shown.

The one or more networks 110 are the medium used to provide communications links between various devices and computers connected together within distributed data processing system 100. The one or more networks 110 may be any type of network capable of conveying information between the remotely monitored/operated avatar 120, the assisted living server 130, and the remote observation center 140. The one or more networks 110 may include connections, such as wired communication links, wireless communication links, satellite communication links, cellular or similar radio based communication links, infrared communication links, fiber optic cables, coaxial cables, and the like.

The one or more networks 110 may include a local area network (LAN), wide area network (WAN), intranet, satellite network, infrared network, radio network, cellular telephone network or other type of wireless communication network, the Internet, and the like.

In the depicted example, network data processing system 100 is the Internet with the one or more networks 110 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages.

In the depicted example, a remotely monitored/operated avatar 120 (hereafter referred to as the “avatar”) is located in the vicinity of a person, pet, or other entity that is to be monitored. The exemplary embodiments of the present invention will assume that a person is the subject of the monitoring by the avatar 120. The avatar 120 is a computerized device that is capable of monitoring the person with various built in sensors, performing processing based on the input from the sensors, and generating interactive commands to control the avatar 120 such that it interacts with the person being monitored.

The avatar 120 is preferably a device having aesthetic qualities that cause the person being monitored to feel a sense of companionship with the avatar. For example, the avatar 120 may be a computerized robotic dog, cat, human, a simulated inanimate object such as a plant, or the like. Alternatively, the avatar 120 may be a fanciful creature that does not necessarily resemble any known animal. Of course, the present invention is not limited to any particular aesthetic quality of the avatar 120 and the avatar 120 may take any form deemed necessary to the particular embodiment.

The avatar 120 may monitor the person using any of a number of different sensors. The sensors may include audio pickup devices, video monitoring devices, aroma detecting devices, vibration sensors, positioning sensors and the like. These sensors provide data that is used by one or more processors located in the avatar and/or the assisted living server 130 to determine instructions for the avatar 120 regarding interaction with the person being monitored. In addition, the sensed data may be forwarded to the remote observation center 140 for use in providing information output to human operators associated with the remote observation center 140. These human operators may then issue instructions to the avatar 120 such that the avatar 120 interacts with the person being monitored.

The sensor data obtained from the sensors in the avatar 120 may be transmitted to the assisted living server 130 and/or the remote observation center 140 via the at least one network 110. The avatar 120 may be equipped with wired or wireless transmission and reception mechanisms, such as a radio transceiver, infrared transceiver, coaxial cable connection, wired or wireless telephone communication connection, cellular or satellite communication connection, Bluetooth™ transceiver, or the like, by which the avatar 120 can transmit and receive data and instructions to and from the at least one network 110.

Bluetooth™ is the name given to a technology standard using short-range radio links, intended to replace the cable(s) connecting portable and/or fixed electronic devices. The standard defines a uniform structure for a wide range of devices to communicate with each other, with minimal user effort. Bluetooth's key features are robustness, low complexity, low power and low cost. The technology also offers wireless access to LANs, public switched telephone networks (PSTN), mobile phone networks, and the Internet for a host of home appliances and portable handheld interfaces.

The sensor data may be processed by a processor associated with the avatar 120 itself to determine interactive commands for controlling the avatar 120 to interact with the person being monitored. For example, the sensor data from a video sensor may indicate that a person being monitored has fallen and is unable to stand up. In such an instance, the avatar 120 may be instructed to audibly ask the person whether they need medical assistance and await a reply. If a reply is not received or an affirmative response is received, as may be determined based on audio sensor data and a corresponding speech recognition application, for example, the avatar 120 may notify emergency services via a wired or wireless communication connection.

Similarly, the avatar 120 may determine, based on an internal clock and schedule information, that a person being monitored is scheduled to take certain medication. The avatar 120 may be instructed to announce to the person that it is time for their medication. The avatar 120 may then dispense the medication based on instructions generated by the internal processor. The above are only examples of the possible processing of sensor data performed by the avatar 120 and other types of processing to generate interactive commands is intended to be within the spirit and scope of the present invention.

In addition to internal processing of the sensor data within the avatar 120, the sensor data may be transmitted to an assisted living server 130 for more complex processing of the sensor data. For example, the avatar 120 may perform rudimentary processing of the sensor data to determine whether to dispense medication, notify the person of various events, and respond to input from the person. More complex processing, such as performing motion detection based on video input to determine whether a person is conscious, determining if an adult is present with a child, determining if a pet's food and/or water supply is low, determining if house plants have been watered and are in good condition, and the like, may be performed by the assisted living server 130. Alternatively, the avatar 120 may perform no appreciable processing of the sensor data and may require that all processing be done in the assisted living server 130 or by an operator at the remote observation center 140.

Based on the processing by the assisted living server 130, instructions may be transmitted to the avatar 120 via the at least one network 110. The avatar 120 may then be operated in accordance with the received instructions from the assisted living server 130 in much the same manner as instructions generated within the avatar 120 itself. The instructions generated by the assisted living server 130 are preferably in a format and protocol that is predefined for use with the avatar 120.

In both the avatar 120 and the assisted living server 130, determination of instructions for the avatar 120 may be made based on various programs stored in memory. In addition, neural network systems, expert systems, rule based systems, inference engines, voice recognition systems, motion detection systems, and the like, may be employed by the avatar 120 and the assisted living server 130 to analyze the received sensor data and determine one or more instructions to be provided to the avatar 120 in response to the received sensor data. Neural network systems, expert systems, rule based systems, inference engines, voice recognition systems and motion detection systems are generally known in the art. These systems may be trained or created based on empirical or historical data obtained by observation and analysis of persons being monitored in many different environments and under various conditions. For example, the avatar according to the present invention may monitor human functions using a motion sensor. The input from the motion sensor may be passed through an intelligent system, such as a neural network, to determine a course of action to take should the motion sensor indicate that the person does not move for a period of time. For example, the intelligent system may be used to select between reporting the person's non-movement to the assisted living server, attempting to wake the person by speaking or nudging, or the like.

Moreover, the sensor data may be transmitted to the remote observation center 140 via the at least one network 110. The remote observation center 140 may then generate a display of the sensor data, or otherwise output the sensor data, via a terminal associated with the remote observation center 140. A human operator manning the terminal may then make decisions regarding instructions to be sent to the avatar 120 based on the received sensor data. The human operator may then generate and transmit the instructions using the terminal associated with the remote observation center 140.

Thus, the present invention provides a distributed data processing system in which an avatar is locally and remotely monitored and operated to interact with a person or other entity under observation. The avatar may be controlled to perform various functions based on sensed data such that the avatar interacts with the person under observation.

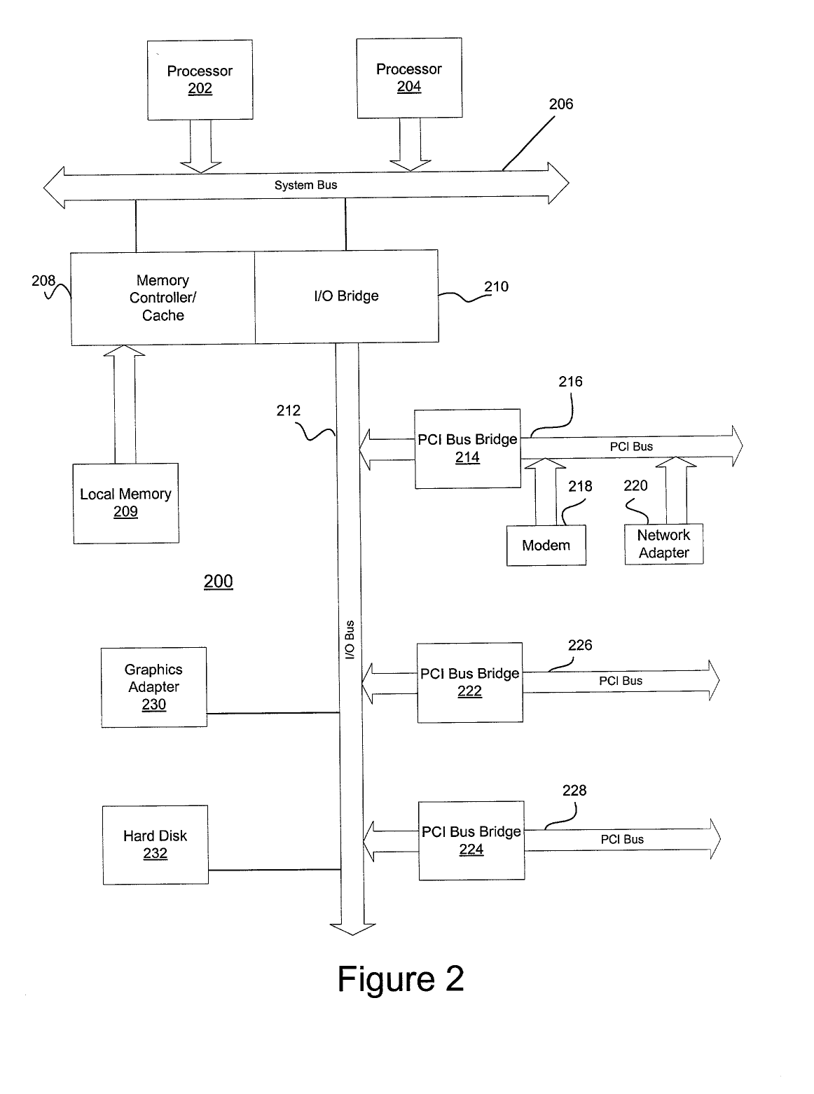

Referring to FIG. 2, a block diagram of a data processing system that may be implemented as an assisted living server is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 maybe provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

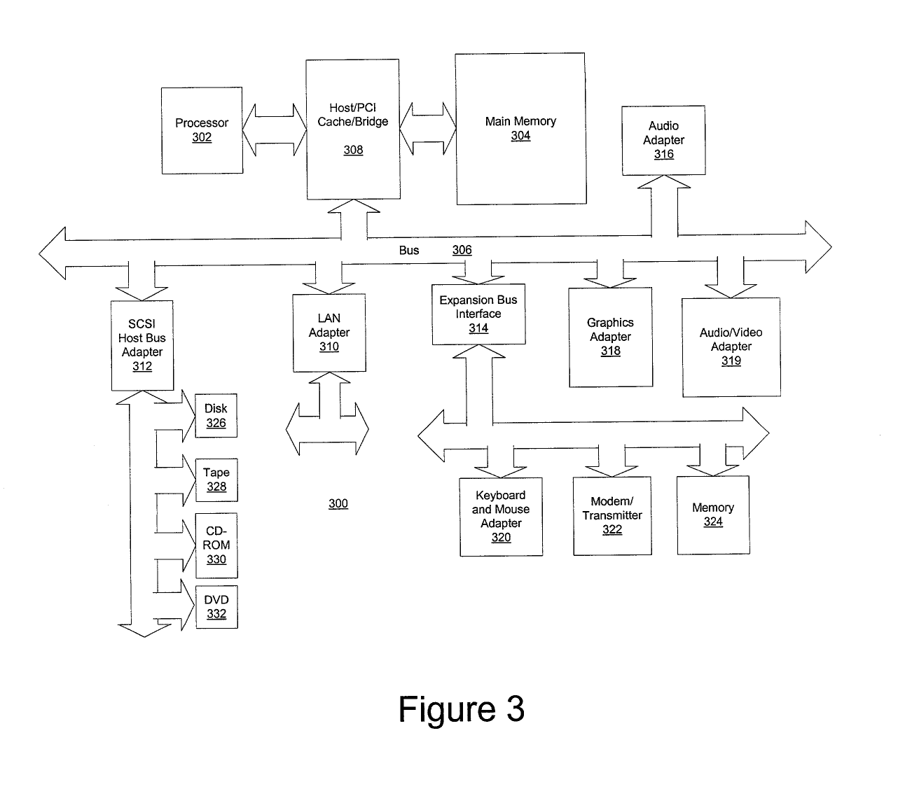

With reference now to FIG. 3, a block diagram illustrating a data processing system of an avatar in accordance with a preferred embodiment of the present invention is provided. Data processing system 300 is an example of a client computer. The data processing system 300 within the avatar 120 is a “client” to the assisted living server 130 and the remote observation center 140.

Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. Instructions for the operating system and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

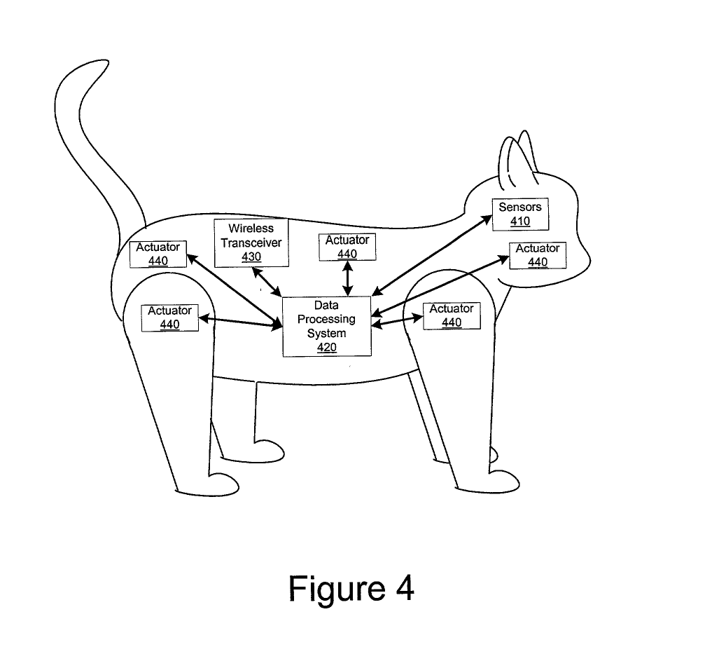

FIG. 4 is an exemplary diagram of a preferred embodiment of an avatar, such as avatar 120 in FIG. 1, according to the present invention. The avatar shown in FIG. 4 is in the form of a domestic cat, however the invention is not limited to such, as mentioned above. The avatar includes sensors 410, a data processing system 420, and a wireless transceiver 430. The sensors 410 and the wireless transceiver 430 are coupled to the data processing system 420 such that data may be received by the data processing system 420 from both the sensors 410 and the wireless transceiver 430 and data may be sent to the wireless transceiver 430 from the data processing system 420.

As mentioned above, the sensors 410 may be any type of sensor for sensing the environment in which the avatar is located. For example, the sensors 410 maybe audio pickup devices, video pickup devices, aroma sensing devices, positioning systems, vibration sensors, and the like. The sensors 410 detect environmental conditions and report these conditions to the data processing system 420 as sensor data.

In addition to sensors 410, the avatar may communicate with systems and devices present in the environment in order to obtain information regarding the environment not obtained from the sensors 410. For example, the avatar may communicate with a thermostat of a building to obtain information regarding the current ambient temperature of the building as well as the current setting of the thermostat for turing on the air-conditioning or heater for the building. Such communication may be performed along wired or wireless connections. In one particular embodiment, the avatar according to the present invention may communicate with devices present in the environment using a wireless Bluetooth™ communication device, such as transceiver 430. Of course other devices in the environment may be in communication with the avatar in this manner including, but not limited to, door locks, light fixture controls, entertainment systems/devices, smoke detection devices/systems, burglar alarm systems, other household appliances, and the like.

The data processing system 420 may be any type of data processing system that is capable of receiving sensor data, performing processing on the sensor data, and generating interactive commands to control the operation of the avatar such that the avatar interacts with the person under observation. The data processing system 420 may be the data processing system depicted in FIG. 3, for example.

The data processing system 420 receives sensor data from the sensor 410, analyzes the sensor data, and generates commands for execution by the avatar such that the avatar interacts with the person under observation. The analysis of the sensor data may include using a neural network, expert system, inference engine, rule based system, and the like, as described above, to determine commands to be executed by the avatar.

Once the commands are determined, the data processing system 420 executes the commands within the avatar. Execution of the commands may entail various operations by the avatar. Such operations may include operating actuators 440 within the avatar to cause portions of the avatar to move, such as the legs, mouth, eyes, tail, and the like. The operations may further include operating audio output devices to cause the avatar to output sound, such as a human voice or animal sound. The operations may further include assistance operations, such as dispensing medication, calling emergency services, sounding an alarm, notifying the remote observation center of a possible emergency, and the like. Other operations may also be performed without departing from the spirit and scope of the present invention.

As described above, rather than performing all processing and analysis within the avatar, processing and analysis may be distributed amongst the avatar, the assisted living server, and the remote observation center, or any portion thereof. For example, sensor data may be received by the data processing system 420 and transmitted to the assisted living server and/or the remote observation center via the wireless transceiver 430. Instructions, i.e. commands, issued by the assisted living server and/or remote observation center based on the sensor data may be received by the avatar via the transceiver 430. The received instructions/commands, may then be forwarded to the data processing system 420 for causing the avatar to execute those instructions/commands. In this way, the avatar is controlled remotely to operate and interact with an entity under observation in accordance with the sensed data.

With a remote observation center, the sensed data is sent from the avatar to the remote observation center which uses the sensed data to generate an output that is perceivable by a human operator. The output may be a graphical display, textual display, audio output, or any combination of graphical display, textual display and audio output. The operator may thus, monitor the entity being observed by the avatar as well as the operation of the avatar itself. Based on these observations, the operator may issue instructions to the avatar to cause the avatar to interact with the entity under observation in accordance with the sensed situation.

For example, often when a person has medicine that must be taken daily, the person keeps such medication in a medication box with the days for the week marked on the box. The avatar according to the present invention can observe the medicine box with a video sensor and determine, based on what day it is and whether there is medication in a corresponding compartment of the medication box, whether the person has taken his/her daily medication. If the person has not taken their medication, the avatar may remind the person to take their medicine.

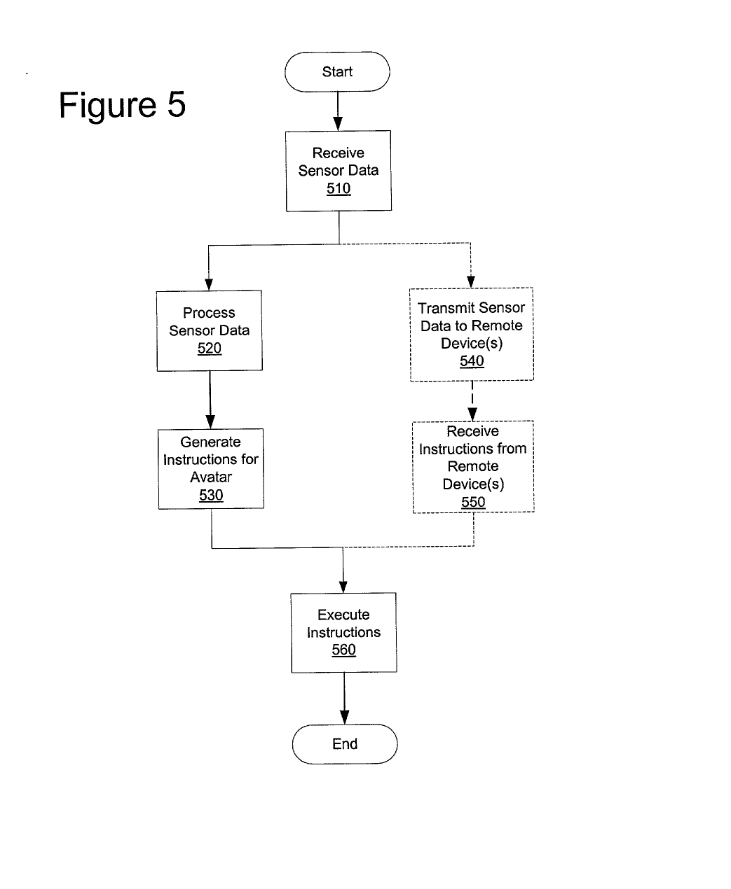

FIG. 5 is a flowchart outlining an exemplary operation of the avatar according to a preferred embodiment of the present invention. As shown in FIG. 5, the operation starts with receiving sensor data from one or more sensors associated with the avatar (step 510). The sensor data is then processed and analyzed (step 520) and instructions are generated for controlling the operation of the avatar based on the sensor data (step 530).

Optionally, at substantially a same time, the sensor data may be sent to a remote assisted living server and/or remote observation center (step 540). Instructions from the assisted living server and/or remote observation center may then be received (step 550).

The instructions are then executed by the avatar in such a manner that the avatar interacts with the person or entity under observation (step 560). The operation then ends.

Thus, the present invention provides a mechanism by which a person or other entity may be remotely monitored using an interactive avatar. The interactive avatar may be operated based on sensed data locally, remotely, or a combination of local and remote operation. The avatar may provide sensed data to a remote assisted living server and/or observation center for use in determining appropriate instructions to issue to the avatar such that the avatar interacts with the entity under observation in accordance with the sensed data.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of controlling an interactive avatar used to interact with an entity, comprising:
sensing at least one environmental condition;
determining at least one instruction based on the at least one environmental condition; and
controlling operation of the avatar based on the at least one instruction such that the avatar interacts with the entity in accordance with the at least one environmental condition.

2. The method of claim 1, wherein the avatar has aesthetic qualities of a pet animal.

3. The method of claim 1, wherein the avatar is one of a computerized animal, human, fanciful creature, and simulated inanimate object.

4. The method of claim 1, wherein sensing at least one environmental condition includes sensing the at least one environmental condition using one or more sensors associated with the avatar.

5. The method of claim 4, wherein the one or more sensors include one or more of an audio pickup device, video monitoring device, an aroma detection device, a vibration sensor, and a position sensor.

6. The method of claim 1, wherein determining at least one instruction based on the at least one environmental condition includes transmitting sensor data representing the at least one environmental condition to a remote server.

7. The method of claim 6, wherein the sensor data representing the at least one environmental condition is transmitted to the remote server using one or more of a radio transceiver, an infrared transceiver, a coaxial cable connection, a wire or wireless telephone communication connection, a cellular or satellite communication connection, and a Bluetooth™ transceiver.

8. The method of claim 1, wherein determining at least one instruction based on the at least one environmental condition includes processing sensor data representing the at least one environmental condition in a processor local to the avatar.

9. The method of claim 1, wherein determining at least one instruction based on the at least one environmental condition includes comparing schedule information to an internal clock of the avatar and generating at least one instruction based on the comparison.

10. The method of claim 1, wherein the at least one instruction includes at least one of an instruction to provide audible output from the avatar, an instruction to generate movement of the avatar, an instruction to generate visual output from the avatar, an instruction to dispense medication from the avatar, an instruction to contact emergency services, an instruction to sound an alarm, and an instruction to notify a remote observation center.

11. The method of claim 1, wherein determining at least one instruction based on the at least one environmental condition includes using one or more of a neural network system, expert system, rule based system inference engine, voice recognition system, and motion detection system to determine the at least one instruction.

12. The method of claim 1, wherein determining at least one instruction based on the at least one environmental condition includes receiving the at least one instruction from a remotely located human operator.

13. The method of claim 1, wherein the method is implemented by the avatar.

14. The method of claim 1, wherein the method is implemented in a distributed data processing system.

15. An apparatus for controlling an interactive avatar used to interact with an entity, comprising:
means for sensing at least one environmental condition;
means for determining at least one instruction based on the at least one environmental condition; and
means for controlling operation of the avatar based on the at least one instruction such that the avatar interacts with the entity in accordance with the at least one environmental condition.

16. The apparatus of claim 15, wherein the avatar has aesthetic qualities of a pet animal.

17. The apparatus of claim 15, wherein the avatar is one of a computerized animal, human, fanciful creature, and simulated inanimate object.

18. The apparatus of claim 15, wherein the means for sensing at least one environmental condition includes one or more sensors associated with the avatar.

19. The apparatus of claim 18, wherein the one or more sensors include one or more of an audio pickup device, video monitoring device, an aroma detection device, a vibration sensor, and a position sensor.

20. The apparatus of claim 15, wherein the means for determining at least one instruction based on the at least one environmental condition includes means for transmitting sensor data representing the at least one environmental condition to a remote server.

21. The apparatus of claim 20, wherein the means for transmitting sensor data includes one or more of a radio transceiver, an infrared transceiver, a coaxial cable connection, a wire or wireless telephone communication connection, a cellular or satellite communication connection, and a Bluetooth™ transceiver.

22. The apparatus of claim 15, wherein the means for determining at least one instruction based on the at least one environmental condition includes means for locally processing sensor data representing the at least one environmental condition in the avatar.

23. The apparatus of claim 15, wherein the means for determining at least one instruction based on the at least one environmental condition includes means for comparing schedule information to an internal clock of the avatar and means for generating at least one instruction based on the comparison.

24. The apparatus of claim 15, wherein the at least one instruction includes at least one of an instruction to provide audible output from the avatar, an instruction to generate movement of the avatar, an instruction to generate visual output from the avatar, an instruction to dispense medication from the avatar, an instruction to contact emergency services, an instruction to sound an alarm, and an instruction to notify a remote observation center.

25. The apparatus of claim 15, wherein the means for determining at least one instruction based on the at least one environmental condition includes one or more of a neural network system, expert system, rule based system inference engine, voice recognition system, and motion detection system.

26. The apparatus of claim 15, wherein the means for determining at least one instruction based on the at least one environmental condition includes means for receiving the at least one instruction from a remotely located human operator.

27. A computer program product in a computer readable medium for controlling an interactive avatar used to interact with an entity, comprising:
first instructions for sensing at least one environmental condition;
second instructions for determining at least one instruction based on the at least one environmental condition; and
third instructions for controlling operation of the avatar based on the at least one instruction such that the avatar interacts with the entity in accordance with the at least one environmental condition.

28. The method of claim 27, wherein the avatar has aesthetic qualities of a pet animal.

29. The method of claim 27, wherein the avatar is one of a computerized animal, human, fanciful creature, and simulated inanimate object.

30. The method of claim 27, wherein sensing at least one environmental condition includes sensing the at least one environmental condition using one or more sensors associated with the avatar.

31. The method of claim 30, wherein the one or more sensors include one or more of an audio pickup device, video monitoring device, an aroma detection device, a vibration sensor, and a position sensor.

32. The method of claim 27, wherein determining at least one instruction based on the at least one environmental condition includes transmitting sensor data representing the at least one environmental condition to a remote server.

33. The method of claim 32, wherein the sensor data representing the at least one environmental condition is transmitted to the remote server using one or more of a radio transceiver, an infrared transceiver, a coaxial cable connection, a wire or wireless telephone communication connection, a cellular or satellite communication connection, and a Bluetooth™ transceiver.

34. The method of claim 27, wherein determining at least one instruction based on the at least one environmental condition includes processing sensor data representing the at least one environmental condition in a processor local to the avatar.

35. The method of claim 27, wherein determining at least one instruction based on the at least one environmental condition includes comparing schedule information to an internal clock of the avatar and generating at least one instruction based on the comparison.

36. The method of claim 27, wherein the at least one instruction includes at least one of an instruction to provide audible output from the avatar, an instruction to generate movement of the avatar, an instruction to generate visual output from the avatar, an instruction to dispense medication from the avatar, an instruction to contact emergency services, an instruction to sound an alarm, and an instruction to notify a remote observation center.

37. The method of claim 27, wherein determining at least one instruction based on the at least one environmental condition includes using one or more of a neural network system, expert system, rule based system inference engine, voice recognition system, and motion detection system to determine the at least one instruction.

38. The method of claim 27, wherein determining at least one instruction based on the at least one environmental condition includes receiving the at least one instruction from a remotely located human operator.

39. The method of claim 27, wherein the method is implemented by the avatar.

40. The method of claim 27, wherein the method is implemented in a distributed data processing system.

41. A method of remotely controlling an interactive avatar used to interact with an entity, comprising:
receiving sensed data from the avatar;
generating at least one instruction based on the sensed data, the at least one instruction being used by the avatar to control operation of the avatar such that the avatar interacts with the entity; and
transmitting the at least one instruction to the avatar.

42. The method of claim 41, wherein the avatar has aesthetic qualities of a pet animal.

43. The method of claim 41, wherein the avatar is one of a computerized animal, human, fanciful creature, and simulated inanimate object.

44. The method of claim 41, wherein transmitting the at least one instruction to the avatar includes transmitting the at least one instruction using one or more of a radio transceiver, an infrared transceiver, a coaxial cable connection, a wire or wireless telephone communication connection, a cellular or satellite communication connection, and a Bluetooth™ transceiver.

45. The method of claim 41, wherein the at least one instruction includes at least one of an instruction to provide audible output from the avatar, an instruction to generate movement of the avatar, an instruction to generate visual output from the avatar, an instruction to dispense medication from the avatar, an instruction to contact emergency services, an instruction to sound an alarm, and an instruction to notify a remote observation center.

46. The method of claim 41, wherein generating at least one instruction based on the sensed data includes using one or more of a neural network system, expert system, rule based system inference engine, voice recognition system, and motion detection system to determine the at least one instruction.

47. A method of controlling an interactive avatar used to interact with an entity, comprising:
receiving, from an external device, information representing at least one environmental condition;
determining at least one instruction based on the information representing the at least one environmental condition; and
controlling operation of the avatar based on the at least one instruction such that the avatar interacts with the entity in accordance with the at least one environmental condition.

48. The method of claim 47, wherein the information representing the at least one environmental condition is received over a wired communication link.

49. The method of claim 47, wherein the information representing the at least one environmental condition is received over a wireless communication link.

50. The method of claim 47, wherein the external device is one of a thermostat, a door lock, a light fixture control, an entertainment system/device, a smoke detection device/system, a burglar alarm system, and a household appliance.
